(19) United States
(12) Patent Application Publication
(10) Pub. No.: US 2019/0236399 A1
(43) Pub. Date: Aug. 1, 2019

(54) VISUAL-INERTIAL SENSOR FUSION FOR NAVIGATION, LOCALIZATION, MAPPING, AND 3D RECONSTRUCTION

(71) Applicant: THE REGENTS OF THE UNIVERSITY OF CALIFORNIA, Oakland, CA (US)

(72) Inventors: Stefano Soatto, Pasadena, CA (US); Konstantine Tsotsos, Los Angeles, CA (US)

(73) Assignee: THE REGENTS OF THE UNIVERSITY OF CALIFORNIA, Oakland, CA (US)

(21) Appl. No.: 16/059,491

(22) Filed: Aug. 9, 2018

Related U.S. Application Data
(63) Continuation of application No. 14/932,899, filed on Nov. 4, 2015, now abandoned.
(60) Provisional application No. 62/075,170, filed on Nov. 4, 2014.

(51) Int. Cl. G06K 9/52; G06T 7/277; G06T 7/579; G01S 5/16; G06K 9/00; G01C 21/16

(52) U.S. Cl. CPC G06K 9/52; G06T 7/277; G01C 21/165; G01S 5/16; G06K 9/00664; G06T 7/579

(57) ABSTRACT

A new method for improving the robustness of visual-inertial integration systems (VINS) based on derivation of optimal discriminants for outlier rejection, and the consequent approximations, that are both conceptually and empirically superior to other outlier detection schemes used in this context. It should be appreciated that VINS is central to a number of application areas including augmented reality (AR), virtual reality (VR), robotics, autonomous vehicles, autonomous flying robots, and so forth and their related hardware including mobile phones, such as for use in indoor localization (in GPS-denied areas), and the like.

### CROSS-REFERENCE TO RELATED APPLICATIONS

This application is a continuation of U.S. patent application Ser. No. 14/932,899 filed on Nov. 4, 2015, incorporated herein by reference in its entirety, which claims priority to, and the benefit of, U.S. provisional patent application Ser. No. 62/075,170 filed on Nov. 4, 2014, incorporated herein by reference in its entirety.

The above-referenced U.S. patent application Ser. No. 14/932,899 was published as United States Patent Application Publication No. US-2016-0140729-A1 on May 19, 2016, incorporated herein by reference in its entirety.

### STATEMENT REGARDING FEDERALLY SPONSORED RESEARCH OR DEVELOPMENT

This invention was made with Government support under HM02101310004, awarded by the National Geospatial-Intelligence Agency. The Government has certain rights in the invention.

### INCORPORATION-BY-REFERENCE OF COMPUTER PROGRAM APPENDIX

Appendix A referenced herein is a computer program listing in a text file entitled “UC-2015-346-3-LA-US-source-code-listing.txt” created on Nov. 4, 2015 and having a 560 kb file size. The computer program code, which exceeds 300 lines, is submitted as a computer program listing appendix through EFS-Web and is incorporated herein by reference in its entirety.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technological Field

This technical disclosure pertains generally to visual-inertial motion estimation, and more particularly to enhancing a visual-inertial integration system (VINS) with optimized discriminants.

### 2. Background Discussion

Sensor fusion systems which integrate inertial (accelerometer, gyrometer) and vision measurements are in demand to estimate 3D position and orientation of the sensor platform, along with a point-cloud model of the 3D world surrounding it. This is best known as VINS (visual-inertial system), or vision-augmented navigation. However, a number of shortcomings arise with VINS in regard to handling the preponderance of outliers to provide proper location tracking.

Accordingly, a need exists for enhanced techniques for use with a VINS, or VINS-like system. These shortcomings are overcome by the present disclosure which provides enhanced handling of outliers, while describing additional enhancements.

### REFERENCES

[1] P. Huber, Robust statistics. New York: Wiley, 1981.

[2] H. Trinh and M. Aldeen, “A memoryless state observer for discrete time-delay systems,” Automatic Control, IEEE Transactions on, vol. 42, no. 11, pp. 1572-1577, 1997.

[3] K. M. Bhat and H. Koivo, “An observer theory for time delay systems,” Automatic Control, IEEE Transactions on, vol. 21, no. 2, pp. 266-269, 1976.

[4] J. Leyva-Ramos and A. Pearson, “An asymptotic modal observer for linear autonomous time lag systems,” Automatic Control, IEEE Transactions on, vol. 40, no. 7, pp. 1291-1294, 1995.

[5] G. Rao and L. Sivakumar, “Identification of time-lag systems via walsh functions,” Automatic Control, IEEE Transactions on, vol. 24, no. 5, pp. 806-808, 1979.

[6] R. Eustice, 0. Pizarro, and H. Singh, “Visually augmented navigation in an unstructured environment using a delayed state history,” in Robotics and Automation, 2004. Proceedings: ICRA'04. 2004 IEEE International Conference on, vol. 1. IEEE, 2004, pp. 25-32.

[7] S. I. Roumeliotis, A. E. Johnson, and J. F. Montgomery,

“Augmenting inertial navigation with image-based motion estimation,” in Robotics and Automation, 2002. Proceedings. ICRA'02. IEEE International Conference on, vol. 4. IEEE, 2002, pp. 4326-4333.

[8] J. Civera, A. J. Davison, and J. M. M. Montiel, “1-point ransac,” in Structure from Motion using the Extended Kalman Filter. Springer, 2012, pp. 65-97.

[9] A. Mourikis and S. Roumeliotis, “A multi-state constraint kalman filter for vision-aided inertial navigation,” in Robotics and Automation, 2007 IEEE International Conference on. IEEE, 2007, pp. 3565-3572.

[10] J. Neira and J. D. Tardus, “Data association in stochastic mapping using the joint compatibility test,” Robotics and Automation, IEEE Transactions on, vol. 17, no. 6, pp. 890-897, 2001.

[11] S. Weiss, M. W. Achtelik, S. Lynen, M. C. Achtelik, L. Kneip, M. Chli, and R. Siegwart, “Monocular vision for long-term micro aerial vehicle state estimation: A compendium,” Journal of Field Robotics, vol. 30, no. 5, pp. 803-831, 2013.

[12] J. Engel, J. Sturm, and D. Cremers, “Scale-aware navigation of a low-cost quadrocopter with a monocular camera,” Robotics and Autonomous Systems (RAS), 2014.

[13] J. Hernandez, K. Tsotsos, and S. Soatto, “Observability, identifiability and sensitivity of vision-aided inertial navigation,” Proc. of IEEE Intl. Conf. on Robotics and Automation (ICRA), May 2015.

[14] R. M. Murray, Z. Li, and S. S. Sastry, A Mathematical Introduction to Robotic Manipulation. CRC Press, 1994.

[15] Y. Ma, S. Soatto, J. Kosecka, and S. Sastry, An invitation to 3D vision, from images to models. Springer Verlag, 2003.

[16] B. Lucas and T. Kanade, “An iterative image registration technique with an application to stereo vision.” Proc. 7th Int. Joint Conf. on Art. Intell., 1981.

[17] E. Jones and S. Soatto, “Visual-inertial navigation, localization and mapping: A scalable real-time large-scale approach,” Intl. J. of Robotics Res., April 2011.

[18] A. Benveniste, M. Goursat, and G. Ruget, “Robust identification of a nonminimum phase system: Blind adjustment of a linear equalizer in data communication,” IEEE Trans. on Automatic Control, vol. Vol AC-25, No. 3, pp. pp. 385-399, 1980.

[19] L. El Ghaoui and G. Calafiore, “Robust filtering for discrete time systems with bounded noise and parametric uncertainty,” Automatic Control, IEEE Transactions on, vol. 46, no. 7, pp. 1084-1089, 2001.

[20] Y. Bar-Shalom and X.-R. Li, Estimation and tracking: principles, techniques and software. YBS Press, 1998.

[21] A. Jazwinski, Stochastic Processes and Filtering Theory. Academic Press, 1970.

[22] B. Anderson and J. Moore, Optimal filtering. Prentice-Hall, 1979.

[23] J. B. Moore and P. K. Tam, “Fixed-lag smoothing for nonlinear systems with discrete measurements,” Information Sciences, vol. 6, pp. 151-160, 1973.

[24] R. Hermann and A. J. Krener, “Nonlinear controllability and observability,” IEEE Transactions on Automatic Control, vol. 22, pp. 728-740, 1977.

[25] G. M. Ljung and G. E. Box, “On a measure of lack of fit in time series models,” Biometrika, vol. 65, no. 2, pp. 297-303, 1978.

[26] S. Soatto and P. Perona, “Reducing “structure from motion”: a general framework for dynamic vision. part 1: modeling.” IEEE Trans. Pattern Anal. Mach. Intell., vol. 20, no. 9, pp. 993-942, September 1998.

[27] - - - - - -, “Reducing “structure from motion”: a general framework for dynamic vision. part 2: Implementation and experimental assessment.” IEEE Trans. Pattern Anal. Mach. Intell., vol. 20, no. 9, pp. 943-960, September 1998.

[28] A. Chiuso, P. Favaro, H. Jin, and S. Soatto, “Motion and structure causally integrated over time,” IEEE Trans. Pattern Anal. Mach. Intell., vol. 24 (4), pp. 523-535,2002.

[29] M. Müller, “Dynamic time warping,” Information retrieval for music and motion, pp. 69-84,2007.

[30] M. Li and A. I. Mourikis, “High-precision, consistent EKF-based visual-inertial odometry,” High-Precision, Consistent EKF-based Visual-Inertial Odometry, vol. 32, no. 4, 2013.

[31] J. A. Hesch, D. G. Kottas, S. L. Bowman, and S. I. Roumeliotis, “Camera-imu-based localization: Observability analysis and consistency improvement,” International Journal of Robotics Research, vol. 33, no. 1, pp. 182-201, 2014.

### BRIEF SUMMARY

Inference of three-dimensional motion from the fusion of inertial and visual sensory data has to contend with the preponderance of outliers in the latter. Robust filtering deals with the joint inference and classification task of selecting which data fits the model, and estimating its state. We derive the optimal discriminant and propose several approximations, some used in the literature, others new. We compare them analytically, by pointing to the assumptions underlying their approximations, and empirically. We show that the best performing method improves the performance of state-of-the-art visual-inertial sensor fusion systems, while retaining the same computational complexity.

This disclosure describes a new method to improve the robustness of VINS, that has pushed the UCLA Vision Lab system to better robustness and performance than performing schemes, including Google Tango. It is based on the derivation of the optimal discriminant for outlier rejection, and the consequent approximations, that are shown to be both conceptually and empirically superior to other outlier detection schemes used in this context. VINS is central to Augmented Reality, Virtual Reality, Robotics, Autonomous vehicles, Autonomous flying robots, and their applications, including mobile phones, for instance indoor localization (in GPS-denied areas), etc.

Further aspects of the presented technology will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The disclosed technology will be more fully understood by reference to the following drawings which are for illustrative purposes only:

FIG. 1 is a block diagram of a visual-inertial fusion system according to a first embodiment of the present disclosure.

FIG. 2 is a block diagram of a visual-inertial fusion system according to a second embodiment of the present disclosure.

FIG. 3 is a flow diagram of feature lifetime in a visual-inertial fusion system according to a second embodiment of the present disclosure.

FIG. 4 is a plot of a tracking path in an approximately 275 meter loop in a building complex, showing drift between tracks, for an embodiment of the present disclosure.

FIG. 5 is a plot of a tracking path in an approximately 40 meter loop in a controlled laboratory environment, showing drift between tracks, for an embodiment of the present disclosure.

FIG. 6 is a plot of a tracking path in an approximately 180 meter loop through a forested area, showing drift between tracks, for an embodiment of the present disclosure.

FIG. 7 is a plot of a tracking path in an approximately 160 meter loop through a crowded hall, showing drift between tracks, for an embodiment of the present disclosure.

### DETAILED DESCRIPTION

### 1. Introduction

Low-level processing of visual data for the purpose of three-dimensional (3D) motion estimation is substantially useless. In fact, easily 60-90% of sparse features selected and tracked across frames are inconsistent with a single rigid motion due to illumination effects, occlusions, and independently moving objects. These effects are global to the scene, while low-level processing is local to the image, so it is not realistic to expect significant improvements in the vision front-end. Instead, it is critical for inference algorithms utilizing vision to deal with such a preponderance of “outlier” measurements. This includes leveraging on other sensory modalities, such as inertials. The present disclosure addresses the problem of inferring ego-motion (visual odometry) of a sensor platform from visual and inertial measurements, focusing on the handling of outliers. This is a particular instance of robust filtering, a mature area of statistical processing, and most visual-inertial integration systems (VINS) employ some form of inlier/outlier test. Different VINS use different methods, making their comparison difficult, while none of these relate their approach analytically to the optimal (Bayesian) classifier.

The approaches presented derive an optimal discriminant, which is intractable, and describes different approximations, some currently used in the VINS literature, others new. These are compared analytically, by pointing to the assumptions underlying their approximations, and empirically testing them. The results show that it is possible to improve the performance of a state-of-the-art system without increasing its computational footprint.

1.1. Related Work

The term “robust” in filtering and identification refers to the use of inference criteria that are more forgiving than the L² norm. They can be considered special cases of Huber functions as in reference [1]. A list of references is seen in a section near the end of the specification. In the special cases of these Huber functions, the residual is reweighted, rather than data being selected (or rejected). More importantly, the inlier/outlier decision is typically instantaneous.

The derivation of the optimal discriminant described in the present disclosure follows from standard hypothesis testing (Neyman-Pearson), and motivates the introduction of a delay-line in the model, and correspondingly the use of a “smoother”, instead of a standard filter. State augmentation with a delay-line is common practice in the design and implementation of observers and controllers for so-called “time-delay systems” as in references [2], [3] or “time lag systems” as per references [4], [5] and has been used in VINS as per references [6], [7].

Various robust inference solutions proposed in the navigation and SLAM (simultaneous localization and mapping) literature, such as One-point Ransac (random sample consensus) as in reference [8], or MSCKF as in reference [9], can also be related to the standard approach. Similarly, reference [10] maintains a temporal window to re-consider inlier/outlier associations in the past, even though it does not maintain an estimate of the past state. It should be appreciated that Ransac is an iterative method for estimating parameters of a model from a set of observed data which contains outliers. The method is non-deterministic in the sense that it produces a reasonable result only with a certain probability which increases in response to allowing more iterations.

Compared to “loose integration” systems, as in references [11], [12] where pose estimates are computed independently from each sensory modality and fused post-mortem, the approach presented herein has the advantage of remaining within a bounded set of the true state trajectory [13]. Also, loose integration systems rely on vision-based inference to converge to a pose estimate, which is delicate in the absence of inertial measurements that help disambiguate local extrema and initialize pose estimates. As a result, loose integration systems typically require careful initialization with controlled motions.

1.2 Notation and Mechanization

The present disclosure adopts the notation as utilized in references [11], [12]: The spatial frame s is attached to Earth and oriented so gravity γ^{T}[0 0 1]^{T}∥γ∥ is known. The body frame b is attached to the IMU. The camera frame c is also unknown, although intrinsic calibration has been performed, so that measurements are in metric units. The equations of motion (“mechanization”) are described in the body frame at time t relative to the spatial frame g_{sb}(t). Since the spatial frame is arbitrary, it is co-located with the body at t=0. To simplify the notation, g_{sb}(t) is simply indicated as g, and likewise for R_{sb}, T_{sb}, ω_{sb}, v_{sb}, thus omitting the subscript sb wherever it appears. This yields a model for pose (R,T) linear velocity v of the body relative to the spatial frame:

$$\{ \begin{matrix}\dot{T} = v \\ \dot{R} = R ( {\hat{ω}}_{imu} - {\hat{ω}}_{b} ) + {n}_{R} \\ \hat{v} = R ( {α}_{imu} - {α}_{b} ) + γ + {n}_{v} \\ {\dot{ω}}_{b} = {ω}_{b} \\ {\hat{α}}_{b} = {ξ}_{b}\end{matrix} \qquad ( 1 )$$

where T(0)=0, R(0)=R₀, gravity γ∈ [symbol] ³ is treated as a known parameter, ωᵢₘᵤ are the gyro measurements, ω_{b} their unknown bias, αᵢₘᵤ the acceleration measurements and α_{b} their unknown bias.

Initially, it is assumed there is a collection of points pᵢ with coordinates Xᵢ∈ [symbol] ³, i=1, . . . , N visible from time t=tᵢ to the current time t. If π: [symbol] ³→ [symbol] ²; X [symbol] [X₁/X₃, X₂/X₃] is a canonical central (perspective) projection, assuming that the camera is calibrated and that the spatial frame coincides with the body frame at time 0, a point feature detector and tracker as in reference [16] yields yᵢ(t) , for all i=1, . . . , N,

yᵢ(t)=π(g ⁻¹(t)pᵢ)+nᵢ(t), t≥0 (2)

where π(g⁻¹(t)pᵢ) is represented in coordinates as

$$\frac{{R}_{1 : 2}^{T} ( t ) ( {X}_{i} - T ( t ) )}{{R}_{3}^{T} ( t ) ( {X}_{i} - T ( t ) )} ,$$

with g(t) [symbol] (R(t), T(t)) and nᵢ(t) which is the measurement noise for the i-th measurement at time t. In practice, the measurements y(t) are known only up to an “alignment” g_{cb} mapping the body frame to the camera:

yᵢ(t)=π(g_{cb}g⁻¹(t)pᵢ)+nᵢ(t)∈ [symbol] (3)

The unknown (constant) parameters pᵢ and g_{cb} can then be added to the state with trivial dynamics:

$$\{ \begin{matrix}{\dot{p}}_{i} = 0 , i = 1 , . . . , N ( j ) \\ {\dot{g}}_{cb} = 0.\end{matrix} \qquad ( 4 )$$

The model of Eqs. (1), (4) with measurements of Eq. (3) can be written compactly by defining the state x={T, R, v, ω_{b}, α_{b}, T_{cb}, R_{cb}} where g=(R,T), g_{cb}=(R_{cb},T_{cb}) and the structure parameters pᵢ are represented in coordinates by Xᵢ=y̅ᵢ(tᵢ)exp(pᵢ), which ensures that Zᵢ=exp(pᵢ) is positive. We also define the known input u={\hat{ω}ᵢₘᵤ, αᵢₘᵤ}={u₁, u₂}, the unknown input v={ω_{b}, ξ_{b}}={v₁, v₂} and the model error w={n_{R}, nᵥ}. After defining suitable functions f(x), c(x), matrix D and h(x,p)=[. . . ,π(R^{T}(Xᵢ−T))^{T}, . . . ]^{T} with p=p₁, . . . , p_{N} the model from Eqs. (1), (4), (3) takes the form:

$$\{ \begin{matrix}\dot{x} = f ( x ) + c ( x ) u + Dv + c ( x ) w \\ \dot{p} = 0 \\ y = h ( x , p ) + n .\end{matrix} \qquad ( 5 )$$

To enable a smoothed estimate we augment the state with a delay-line: For a fixed interval dt and 1≤n≤k, define xₙ(t) [symbol] g(t−ndt), x^{k} [symbol] {x₁, . . . , xₖ} that satisfies

$$\begin{matrix}{x}^{k} ( t + dt ) \dot{=} {Fx}^{k} ( t ) + Gx ( t ) where & ( 6 ) \\ F \dot{=} [ \begin{matrix}0 & & & \\ I & 0 & & \\ & & & \\ 0 & ⋯ & I & 0\end{matrix} ] , Gx ( t ) \dot{=} [ \begin{matrix}g ( t ) \\ 0 \\ ⋮ \\ 0\end{matrix} ] & ( 7 )\end{matrix}$$

and x≐{x, x₁, . . . , xₖ}={x, X^{k}}. A k-stack of measurements yⱼ^{k}(t)={yⱼ(t), yⱼ(t−dt), . . . , yⱼ(t−kdt)} can be related to the smoother's state x(t) by

yⱼ(t)=h^{k}(x(t), pⱼ)+nⱼ(t) (8)

where we omit the superscript k from y and n, and

h^{k}(x(t), pⱼ) [symbol] [h(x(t), pⱼ)π(x₁(t)pⱼ) . . . π(xₖ(t)pⱼ)]^{T} (9)

It should be noted that nᵢ is not temporally white even if ηⱼ is. It will be appreciated that the White test is a statistical test for time series data where it implies that the time series has no autocorrelation, so it is temporally un-correlated. In the present disclosure, this means that the residual difference between the predicted measurements using the estimate of the state and the actual measurement should be temporally uncorrelated (see also Section 2.1). The overall model is then

$$\{ \begin{matrix}\dot{x} = f ( x ) + c ( x ) u + Dv + c ( x ) w \\ {x}^{k} ( t + dt ) = {Fx}^{k} ( t ) + Gx ( t ) \\ {\dot{p}}_{j} = 0 \\ {y}_{j} ( t ) = {h}^{k} ( x ( t ) , {p}_{j} ) + {n}_{j} ( t ) , t \geq {t}_{j} , j = 1 , . . . , N ( t )\end{matrix} \qquad ( 10 )$$

The observability properties of Eq. (10), are the same as Eq. (5), and are studied in reference [13], where it is shown that Eq. (5) is not unknown-input observable, as given by claim 2 in that paper, although it is observable with no unknown inputs as in reference [17]. This means that, as long as gyro and acceleration bias rates are not identically zero, convergence of any inference algorithm to a unique point estimate cannot be guaranteed. Instead, reference [13] explicitly computes the indistinguishable set (claim 1 of that reference) and bounds it as a function of the bound on the acceleration and gyro bias rates.

### 2. Robust Filtering Description

In addition to the inability of guaranteeing convergence to a unique point estimate, the major challenge of VINS is that the majority of imaging data yᵢ(t) does not fit Eq. (5) due to specularity, transparency, translucency, inter-reflections, occlusions, aperture effects, non-rigidity and multiple moving objects. While filters that approximate the entire posterior, such as particle filters, in theory address this issue, while in practice the high dimensionality of the state space makes them intractable. A goal of the present disclosure is thus to couple the inference of the state with a classification to detect which data are inliers and which are outliers, and discount or eliminate the latter from the inference process. It will be recognized that “inliers” are data (e.g., feature coordinates) having a distribution following some set of model parameters, while “outliers” comprise data (e.g., noise) that do not fit the model.

In this section we derive the optimal classifier for outlier detection, which is also intractable, and describe approximations, showing explicitly under what conditions each is valid, and therefore allowing comparison of existing schemes, in addition to suggesting improved outlier rejection procedures. For simplicity, we assume that all points appear at time t=0, and are present at time t, so we indicate the “history” of the measurements up to time t as y^{t}={y(0), . . . ,y(t)} (we will lift this assumption in Section 3). We indicate inliers with pⱼ, j∈J, with J⊂[1, . . . , N] the inlier set, and assume |J|<<N , where |J| is the cardinality of J.

While a variety of robust statistical inference schemes have been developed for filtering, as in references [18], [19], [1], [20], most of these operate under the assumption that the majority of data points are inliers, which is not the case here.

### 2.1. Optimal Discriminant

In this section and the two following sections, we will assume (note that the first assumption carries no consequence in the design of the discriminant, the latter will be lifted in Sect. 2.4.) that the inputs u, v are absent and the parameters pᵢ are known, which reduces Eq. (5) to the standard form

$$\{ \begin{matrix}\dot{x} = f ( x ) + w \\ y = h ( x ) + n .\end{matrix} \qquad ( 11 )$$

To determine whether a datum yⱼ is inlier, we consider the event I [symbol] {i∈J} (i is an inlier), compute its posterior probability (i.e., the statistical probability that a hypothesis is true calculated in the light of relevant observations given all the data up to the current time), P[I|y^{t}], and compare it with the alternate P[Ī|y^{t}] where Ī [symbol] {i∉J} using the posterior ratio

$$L ( i \vert {y}^{t} ) \dot{=} \frac{P [ I \vert {y}^{t} ]}{P [ \overline{I} \vert {y}^{t} ]} = \frac{{P}_{in} ( {y}_{t}^{i} \vert {y}_{- i}^{t} )}{{P}_{out} ( {y}_{i}^{t} )} ( \frac{ɛ}{1 - ɛ} ) \qquad ( 12 )$$

where y₋ᵢ [symbol] {yⱼ|j≠i} are all data points but the i-th, pᵢₙ(yⱼ) [symbol] p(yⱼ|j∈J) is the inlier density, pₒᵤₜ (yⱼ) [symbol] p(yⱼ|j∈J) is the outlier density, and ε [symbol] P(i∈J) is the prior. It should be noted that the decision on whether i is an inlier cannot be made by measuring yᵢ^{t} alone, but depends on all other data points y₋ᵢ¹ as well. Such a dependency is mediated by a hidden variable, the state x, as we describe next.

### 2.2. Filtering-Based Computation

The probabilities pᵢₙ(y_{Js}^{t}) for any subset of the inlier set u_{Js} [symbol] {yⱼ|j∈Jₛ⊂J} can be computed recursively at each t (we omit the subscript Jₛ for simplicity):

$${p}_{in} ( {y}^{t} ) = {\prod }_{k = 1}^{t} p ( y ( k ) \vert {y}^{k - 1} ) . \qquad ( 13 )$$

The smoothing state x^{t} for Eq. (11) has the property of making “future” inlier measurements yᵢ(t+1), i∈J conditionally independent of their “past” yᵢ^{t}:yᵢ(t+1)⊥yᵢ^{t}|x(t)∀i∈J as well as making the time series of (inlier) data points independent of each other: yᵢ^{t}⊥yⱼ^{t}|x^{t}∀i≠j∈J. Using these independence conditions, the factors in Eq. (13) can be computed through standard filtering techniques as in reference [21] as

p(y(k)|y^{k-1})=∫p(y(k)|xₖ)dP(xₖ₋₁)dP(xₖ₋₁|y^{k-1}) (14)

starting from p(y_{J}(1)|0), where the density p(xₖ|y^{k}) is maintained by a filter (in particular, a Kalman filter when all the densities at play are Gaussian). Conditioned on a hypothesized inlier set J₋ᵢ (not containing i), the discriminant

$$L ( i \vert {y}^{t} , {J}_{- i} ) = \frac{{P}_{in} ( {y}_{t}^{i} \vert {y}_{J - i}^{t} )}{{P}_{out} ( {y}_{i}^{t} )} \frac{ɛ}{( 1 - ɛ )}$$

can then be written as

$$L ( i \vert {y}^{t} , {J}_{- 1} \vert ) = \frac{\int {p}_{in} ( {y}_{i}^{t} \vert {x}^{t} ) dP ( {x}^{t} \vert {y}_{{J}_{- i}}^{t} )}{{P}_{out} ( {y}_{i}^{t} ) } \frac{ɛ}{( 1 - ɛ )} \qquad ( 15 )$$

with x^{t}={x(0), . . . , x(t)}.

The smoothing density P(x^{t}|_{J-i}^{t}) in Eq. (15) is maintained by a smoother as in reference [22], or equivalently a filter constructed on the delay-line as in reference [23]. The challenge in using this expression is that we do not know the inlier set J₋ᵢ; thus, to compute the discriminant of Eq. (12) let us observe that

$$\begin{matrix}{p}_{in} ( {y}_{i}^{t} \vert {y}_{- i}^{t} ) = {\sum }_{{J}_{- t} ∈ {P}_{- t}^{N}} p ( {y}_{i}^{t} , {J}_{- i} ⋃ \{ i \} \vert {y}_{- i}^{t} ) \\ = {\sum }_{{J}_{- t} ∈ {P}_{- t}^{N}} {p}_{in} ( {y}_{i}^{t} \vert {y}_{J - i}^{t} ) P [ {J}_{- i} \vert {y}_{- i}^{t} ]\end{matrix} \qquad ( 16 )$$

where P₋ᵢ^{N} is the power set of [1, . . . , N] not including i. Therefore, to compute the posterior ratio of Eq. (12), we have to marginalize J₋ᵢ, for example by averaging Eq. (15) over all possible J₋ᵢ∈P₋ᵢ^{N}

$$L ( i \vert {y}^{t} ) = {\sum }_{{J}_{- t} ∈ {P}_{- t}^{N}} L ( i \vert {y}^{t} , {J}_{- i} ) P [ {J}_{- i} \vert {y}^{t} ] \qquad ( 17 )$$

### 2.3. Complexity of the Hypothesis Set

For the filtering p(xₜ|y_{J}^{t}) or smoothing densities p(x^{t}|y_{J}^{t}) to be non-degenerate, the underlying model has to be observable as described in reference [24], which depends on the number of (inlier) measurements |J|, with |J| the cardinality of J. We indicate with κ the minimum number of measurements necessary to guarantee observability of the model. Computing the discriminant of Eq. (15) on a sub-minimal set (a set Jₛ with |Jₛ|<κ does not guarantee outlier detection, even if Jₛ is “pure” (only includes inliers). Vice-versa, there is diminishing return in computing the discriminant of Eq. (15) on a super-minimal set (a set Jₛ with |Jₛ|>>κ). The “sweet spot” (optimized discriminant) is a putative inlier (sub)set Jₛ, with |Jₛ|≥κ, that is sufficiently informative, in the sense that the filtering, or smoothing, densities satisfy

dP(x^{t}|y_{J}_{ₛ})≅dP(x^{t}|y_{sJ}^{t}) (18)

In this case, Eq. (12) which can be written as in Eq. (17) by marginalizing over the power set not including i , can be broken down into the sum over pure (J₋₁⊆J) and non-pure sets (J₋₁/⊆J) , with the latter gathering a small probability (note that P[J₋ᵢ|y₋ᵢ^{t}] should be small when J₋₁ contains outliers, for example when (J₋₁/⊆J)).

$$L ( i \vert {y}^{t} ) ≃ {\sum }_{{J}_{- i} ∈ {P}_{- i} , {J}_{- i} ⊆ J} L ( i \vert {y}^{t} , {J}_{- i} \vert ) P [ {J}_{- i} \vert {y}_{- i}^{t} ] \qquad ( 19 )$$

and the sum over sub-minimal sets further isolated and neglected, so

$$L ( i \vert {y}^{t} ) ≃ {\sum }_{{J}_{- i} ∈ {P}_{- i} , {J}_{- i} ⊆ J , \vert {J}_{- i} \vert \geq κ} L ( i \vert {y}^{t} , {J}_{- i} \vert ) P [ {J}_{- i} \vert {y}_{- i}^{t} ] \qquad ( 20 )$$

Now, the first term in the sum is approximately constant by virtue of Eq. (15) and Eq. (18), and the sum ΣP[J₋ᵢ|y₋ᵢ^{t}] is a constant. Therefore, the decision using Eq. (12) can be approximated with the decision based on

Eq. (15) up to a constant factor:

$$L ( i \vert {y}^{t} ) ≃ L ( i \vert {y}^{t} , {J}_{s} ) {\sum }_{{{J}_{- i} ∈ {P}_{- i} ,}_{{{J}_{- i} ⊆ J ,}_{\vert {J}_{- i} \vert \geq κ}}} P [ {J}_{- i} \vert {y}_{- i}^{t} ] ∝ L ( i \vert {y}^{t} , {J}_{s} ) \qquad ( 21 )$$

where Jₛ is a fixed pure (Jₛ⊆J) and minimal (|Jₛ|=κ) estimated inlier set, and the discriminant therefore becomes

$$L ( i \vert {y}^{t} ; {J}_{s} \vert ) = \frac{\int {p}_{in} ( {y}_{i}^{t} \vert {x}^{t} ) dP ( {x}^{t} \vert {y}_{{J}_{s}}^{t} )}{{P}_{out} ( {y}_{i}^{t} ) } \frac{ɛ}{( 1 - ɛ )} . \qquad ( 22 )$$

While the fact that the constant is unknown makes the approximation somewhat unprincipled, the derivation above shows under what (sufficiently informative) conditions one can avoid the costly marginalization and compute the discriminant on any minimal pure set Jₛ. Furthermore, the constant can be chosen by empirical cross-validation along with the (equally arbitrary) prior coefficient ε.

Two constructive procedures for selecting a minimal pure set are discussed next.

(1) Bootstrapping: The outlier test for a datum i , given a pure set Jₛ, consists of evaluating Eq. (22) and comparing it to a threshold. This suggests a bootstrapping procedure, starting from any minimal set or “seed” J_{κ} with |J_{κ}|=κ, by defining

[symbol]

_{κ} [symbol] {i|L(i|yₖ_{₁}^{t}, J_{κ})≥θ>1} (23)

and adding it to the inlier set:

Ĵ=J_{κ}∪ [symbol] _{κ}. (24)

Note that in some cases, such as VINS, it may be possible to run this bootstrapping procedure with fewer points than the minimum, and in particular x=0, as inertial measurements provide an approximate (open loop) state estimate that is subject to slow drift, but with no outliers. It should be appreciated, however, that once an outlier corrupts the inlier set, it will spoil all decisions thereafter, so acceptance decisions should be made conservatively. The bootstrapping approach described above, starting with κ=0 and restricted to a filtering (as opposed to smoothing) setting, has been dubbed “zero-point RANSAC.” In particular, when the filtering or smoothing density is approximated with a Gaussian \hat{p}(x^{t}|y_{K}_{ₛ}^{t})= [symbol] (\hat{x}^{t}; P(t)) for a given inlier set Jₛ, it is possible to construct the (approximate) discriminant of Eq. (22), or to simply compare the numerator to a threshold

$$\int {p}_{in} ( {y}_{i}^{t} \vert {x}^{t} ) \hat{p} ( {x}^{t} \vert {y}_{{J}_{s}}^{t} ) {dx}^{t} ≃ G ( {y}_{i}^{t} - h ( {\hat{x}}^{t} ) ; \\ CP ( t ) {C}^{T} + R ) \geq \frac{1 - ɛ}{ɛ} {p}_{out} ( {y}_{i}^{t} ) ≃ θ$$

where C is the Jacobian of h at \hat{x}^{t}. Under the Gaussian approximation, the inlier test reduces to a gating of the weighted (Mahalanobis) norm of the smoothing residual:

i ∈J⇔∥yᵢ^{t}−h(\hat{x}^{t})∥_{CP(t)C}_{^{T}}_{+R}≤\tilde{θ} (25)

assuming that \hat{x} and P are inferred using a pure inlier set that does not contain i. Here \tilde{θ} is a threshold that lumps the effects of the priors and constant factor in the discriminant, and is determined by empirical cross-validation. In reality, in VINS one must contend with an unknown parameter for each datum, and the asynchronous births and deaths of the data, which we address in Sections 2.4 and 3.

(2) Cross-validation: Instead of considering a single seed J_{κ} in hope that it will contain no outliers, one can sample a number of putative choices {J₁, . . . , Jₗ} and validate them by the number of inliers each induces. In other words, the “value” of a putative (minimal) inlier set J_{L} is measured by the number of inliers it induces:

Vₗ| [symbol] ₗ| (26)

and the hypothesis gathering the most votes is selected

Ĵ [symbol] _{argmax}_{ₗ}_{(V}_{ₗ}) (27)

As a special case, when Jᵢ={i} this corresponds to “leave-all-out” cross-validation, and has been called “one-point Ransac” in reference [8]. For this procedure to work, certain conditions have to be satisfied, in particular,

CⱼP_{t+1|t}Cᵢ^{T}≠0. (28)

It should be noted, however, that when Cᵢ is the restriction of the

Jacobian with respect to a particular state, as is the case in VINS, there is no guarantee that the condition of Eq. (28) is satisfied.

(3) Ljung-Box whiteness test: The assumptions on the data formation model imply that inliers are conditionally independent given the state x^{t} , but otherwise exhibit non-trivial correlations. Such conditional independence implies that the history of the prediction residual (innovation) εᵢ^{t} [symbol] ^{y}ᵢ^{t}−ŷᵢ^{t} is white, which can be tested from a sufficiently long sample as in reference [25]. Unfortunately, in our case the lifetime of each feature is in the order of few tens, so we cannot invoke asymptotic results. Nevertheless, in addition to testing the temporal mean of εᵢ^{t} and its zero-lag covariance of Eq. (25), we can also test the one-lag, two-lag, up to a fraction of κ-lag covariance. The sum of their square corresponds to a small sample version of Ljung-Box test as in reference [25].

### 2.4. Dealing with Nuisance Parameters

The density p(yᵢ^{t}|x(t)) or p(yᵢ^{t}|x^{t}), which is needed to compute the discriminant, may require knowledge of parameters, for instance pᵢ in VINS Eq. (5). The parameter can be included in the state, as done in Eq. (5), in which case the considerations above apply to the augmented state {x, p}. Otherwise, if a prior is available, dP (pᵢ), it can be marginalized via

p(yᵢ^{t}|x^{t})=∫p(yᵢ^{t}|x^{t}, pᵢ)dP(pᵢ) (29)

This is usually intractable if there is a large number of data points. Alternatively, the parameter can be “max outed” from the density

$$p ( {y}_{i}^{t} \vert {x}^{t} ) \dot{=} {max}_{{p}_{i}} p ( {y}_{i}^{t} \vert {x}^{t} , {p}_{i} ) . \qquad ( 30 )$$

or equivalently p(yᵢ^{t}|x^{t}, \hat{p}ᵢ) where \hat{p}ᵢ=arg max_{d} p(yᵢ^{t}|x^{t}, d). The latter is favored in our implementation as described in Section 3 below, which is in line with standard likelihood ratio tests for composite hypotheses.

### 3. Implementation

The state of the models in Eq. (5) and Eq. (10) is represented in local coordinates, whereby R and R_{cb} are replaced by Ω, Ω_{cb}∈ [symbol] ³ such that R=exp(\hat{Ω}) and R_{cb}=exp(\hat{Ω}_{cb}). Points pⱼ are represented in the reference frame where they first appear tⱼ, by the triplet {g(tⱼ), yⱼ, pⱼ} via pⱼ [symbol] g(tⱼ)y̅ⱼ exp(pⱼ), and also assumed constant (rigid). The advantage of this representation is that it enables enforcing positive depth Z=exp(pⱼ), known uncertainty of yⱼ (initialized by the measurement yⱼ(tⱼ) up to the covariance of the noise), and known uncertainty of g(tⱼ) (initialized by the state estimate up to the covariance maintained by the filter). It will be noted also that the representation is redundant, for pⱼ [symbol] g(tⱼ)g̅g̅⁻¹y̅ⱼ exp(pⱼ) [symbol] \tilde{y}ⱼ exp(\tilde{p}ⱼ) for any g∈SE in Eq. (3), and therefore we can assume without loss of generality that g(tⱼ) is fixed at the current estimate of the state, with no uncertainty. Any error in the estimate of g(tⱼ), say g̅, will be transferred to an error in the estimate of \tilde{y}ⱼ and \tilde{p}ⱼ as in reference [13].

Given that the power of the outlier test of Eq. (22) increases with the observation window, it is advantageous to make the latter as long as possible, that is from birth to death. The test can be run at death, and if a point is deemed an inlier, it can be used (once) to perform an update, or else discarded. In this case, the unknown parameter pᵢ must be eliminated using one of the methods described above. This is called an “out-of-state update” because the index i is never represented in the state; instead, the datum yᵢ is just used to update the state x. This is the approach advocated by reference [9], and also in references [26], [27] where all updates were out-of-state. Unfortunately, this approach does not produce consistent scale estimates, which is why at least some of the dⱼ must be included in the state as in reference [28]. To better isolate the impact of outlier rejection, our implementation does not use “out-of-state” updates, but we do initialize feature parameters using Eq. (30).

If a minimum observation interval is chosen, points that are accepted as inliers (and still survive) can be included in the state by augmenting it with the unknown parameter pᵢ with a trivial dynamic \dot{p}ᵢ=0. Their posterior density is then updated together with that of x (t), as customary. These are called “in-state” points. The latter approach is preferable in its treatment of the unknown parameter pᵢ, as it estimates a joint posterior given all available measurements, whereas the out-of-state update depends critically on the approach chosen to deal with the unknown depth, or its approximation. However, computational considerations, as well as the ability to defer the decision on which data are inliers and which outliers as long as possible, may induce a designer to perform out-of-state updates at least for some of the available measurements as in reference [9].

The prediction for the model of Eq. (10) proceeds in a standard manner by numerical integration of the continuous-time component. We indicate the mean \hat{x}_{t|τ} [symbol] E(x(t)|y^{τ}) , where y^{τ} denotes all available measurements up to time τ; then we have

$$\{ \begin{matrix}{\hat{x}}_{t + dt \vert t} = {\int }_{t}^{t + dt} f ( {x}_{τ} ) + c ( {x}_{τ} ) u ( τ ) d τ , {x}_{t} = {\hat{x}}_{t \vert t} \\ {\hat{x}}_{t + dt \vert t}^{k} = F {{\hat{x}}_{x}^{k}}_{t \vert t} + C {\hat{x}}_{t \vert t}\end{matrix} \qquad ( 31 )$$

whereas the prediction of the covariance is standard from the Kalman filter/smoother of the linearized model.

Informed by the analysis above, we have disclosed and implemented six distinct update and outlier rejection models (m1, . . . , m6) that leverage the results of Section 2 and we empirically evaluate them in Section 4. Our baseline models do not use a delay-line, and test the instantaneous innovation with either zero-point (m1) or one-point RANSAC (m2) .

It should be appreciated that the update requires special attention, since point features can appear and disappear at any instant. For each point pⱼ, at time t+dt the following cases arise:
(i) t+dt=tⱼ (feature appears): ŷⱼ [symbol] yⱼ(tⱼ)≅yⱼ is stored and g(tⱼ) is fixed at the current pose estimate (the first two components of \hat{x}_{t+dt|t}).
(ii) t−kdt<tⱼ<t+dt (measurement stack is built): yⱼ(t) is stored in yⱼ^{k}(t).
(iii) t=tⱼ+kdt (parameter estimation): The measurement stack and the smoother state \hat{x}_{t+dt|t} are used to infer pⱼ:

$$\begin{matrix}{\hat{p}}_{j} = arg {min}_{{p}_{j}} ‖ ɛ ( t , {p}_{j} ) ‖ where & ( 32 ) \\ ɛ ( t , {p}_{j} ) \dot{=} {y}_{j} ( t ) - {h}^{k} ( {\hat{x}}_{t \vert {t}_{j}} , {p}_{j} ) . & ( 33 )\end{matrix}$$

To perform an Inlier test the “pseudo-innovation” ε(t, \hat{p}ⱼ) is computed and used to test for consistency with the model according to Eq. (25) and, if pⱼ is deemed an inlier, and if resources allow, we can insert pⱼ into the state initialized with

$${p}_{{j}_{t \vert {t}_{j}}} \dot{=} {\hat{p}}^{j}$$

and compute the “in-state update”:

$${[ \begin{matrix}\hat{x} \\ {\hat{x}}^{k} \\ {\hat{p}}_{j}\end{matrix} ]}_{t \vert t} = {[ \begin{matrix}\hat{x} \\ {\hat{x}}^{k} \\ {\hat{p}}_{j}\end{matrix} ]}_{t \vert {t}_{j}} + L ( t ) ɛ ( t , {\hat{p}}_{{j}_{t \vert {t}_{j}}} ) \qquad ( 34 )$$

where L(t) is the Kalman gain computed from the linearization.

(iv) t>tⱼ+kdt: If the feature is still visible and in the state, it continues being updated and subjected to the inlier test. This can be performed in two ways:
(a) Batch Update: The measurement stack yⱼ(t) is maintained, and the update is processed in non-overlapping batches (stacks) at intervals kdt, using the same update Eq. (34), either with zero-point (m5) or 1-point RANSAC (m6) tests on the smoothing innovation ε:

$${[ \begin{matrix}\hat{x} \\ {\hat{x}}^{k} \\ {\hat{p}}_{j}\end{matrix} ]}_{t + kdt \vert t + kdt} = {[ \begin{matrix}\hat{x} \\ {\hat{x}}^{k} \\ {\hat{p}}_{j}\end{matrix} ]}_{t + kdt \vert t} + L ( t + kdt ) ɛ ( t + kdt , {\hat{p}}_{{j}_{t + kdt \vert t}} ) \qquad ( 35 )$$

(b) History-of-innovation Test Update: The (individual) measurement yⱼ(t) is processed at each instant with either zero-point (m3) or 1-point RANSAC (m4):

$${[ \begin{matrix}\hat{x} \\ {\hat{x}}^{k} \\ {\hat{p}}_{j}\end{matrix} ]}_{t + dt \vert t + dt} = {[ \begin{matrix}\hat{x} \\ {\hat{x}}^{k} \\ {\hat{p}}_{j}\end{matrix} ]}_{t + dt \vert t} + L ( t + dt ) ( {y}_{j} ( t + dt ) - h ( {\hat{x}}_{t + dt \vert t} , {\hat{p}}_{{j}_{t + dt \vert t}} ) ) \qquad ( 36 )$$

while the stack for yⱼ(t+dt) is used to determine those points j for which the history of the (pseudo)-innovation ε(t+dt, \hat{p}ⱼ_{_{t+dt|t}}) is sufficiently white, by performing the inlier test using Eq. (25).

It should be appreciated that in the first case one cannot perform an update at each time instant, as the noise nⱼ(t) is not temporally white. In the second case, the history of the innovation is not used for the filter update, but just for the inlier test. Both approaches differ from standard robust filtering that only relies on the (instantaneous) innovation, without exploiting the time history of the measurements.

### 3.1 System Embodiments

The visual-inertial sensor fusion system generally comprises an image source, a 3-axis linear acceleration sensor, a 3-axis rotational velocity sensor, a computational processing unit (CPU), and a memory storage unit. The image source and linear acceleration and rotational velocity sensors provide their measurements to the CPU module. An estimator module within the CPU module uses measurements of linear acceleration, rotational velocity, and measurements of image interest point coordinates in order to obtain position and orientation estimates for the visual-inertial sensor fusion system. Image processing is performed by the to determine positions over time of a number of interest points (termed “features”) in the image, and provides them to a feature coordinate estimation module, which uses the positions of interest points and the current position and orientation from the Estimator module in order to hypothesize the three-dimensional coordinates of the features. The hypothesized coordinates are tested for consistency continuously over time by a statistical testing module, which uses the history of position and orientation estimates to validate the feature coordinates. Features which are deemed consistent are provided to the estimator module to aid in estimating position and orientation, and continually verified by statistical testing while they are visible in images provided by the image source. Once features are no longer provided by the image processing module, their coordinates and image information are stored in memory by a feature storage module, which provides access to previously used features for access by an image recognition module, which compares past features to those most recently verified by statistical testing. If the image recognition module determines that features correspond, it will generate measurements of position and orientation based on the correspondence to be used by the estimator module.

The following describes specific embodiments of the visual-inertial sensor fusion system.

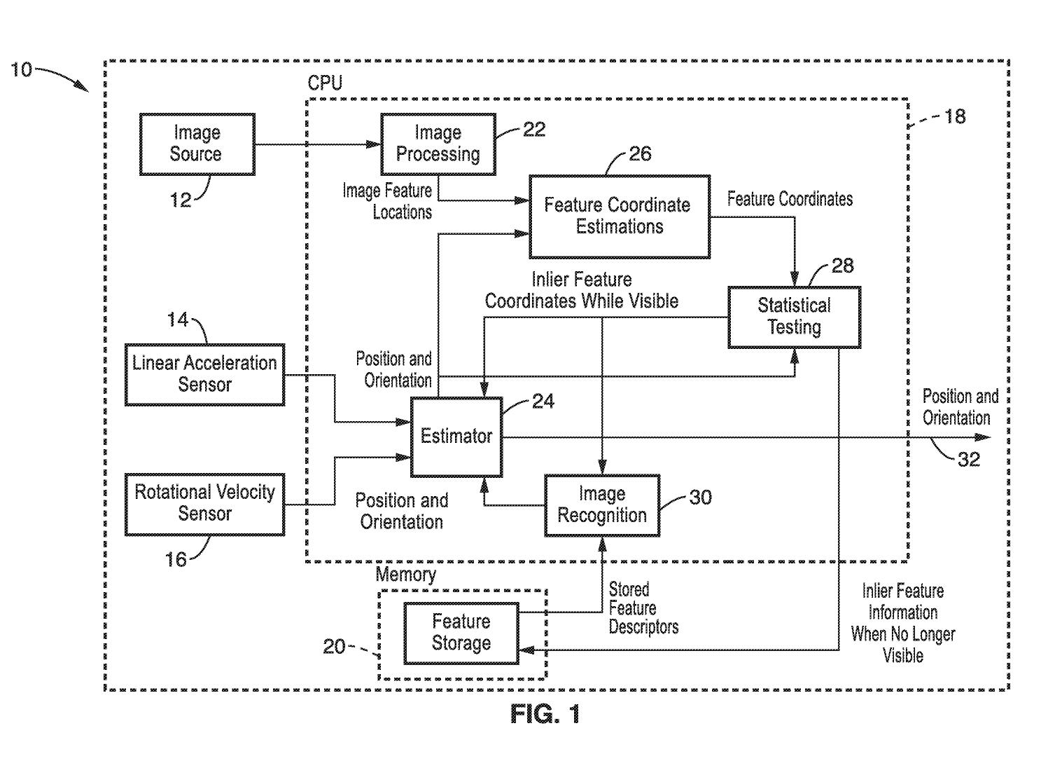

FIG. 1 illustrates a high level diagram of embodiment 10, showing image source 12 configured for providing a sequence of images over time (e.g., video), a linear acceleration sensor 14 for providing measurements of linear acceleration over time, a rotational velocity sensor 16 for providing measurements of rotational velocity over time, a computation module 18 (e.g., at least one computer processor), memory 20 for feature storage, with position and orientation information being output 32.

The following describes the process steps performed by processor 18. Image processing 22 performs image feature selection and tracking utilizing images provided by image source 12. For each input image, the image processing block outputs a set of coordinates on the image pixel grid, for feature coordinate estimation 26. When first detected in the image (through a function of the pixel intensities), a feature's coordinates will be added to this set, and the feature will be tracked through subsequent images (it's coordinates in each image will remain a part of the set) while it is still visible and has not been deemed an outlier by the statistical testing block 28 (such as in a robust test).

Feature coordinate estimation 26 receives a set of feature coordinates from image processing 22, along with estimates from a 3D motion estimator 24. On that basis coordinates are estimated and an estimate of the coordinates of each feature in 3D (termed triangulation) is output.

In statistical testing, the feature coordinates are received from block 22, along with position and orientation information from the estimator 24. The operation of this block is important as it significantly differentiates the present disclosure from other systems. During statistical testing, the estimated feature coordinates received from block 26 of all features currently tracked by image processing block 22 and the estimate of position and orientation over time from estimator 24 are tested statistically against the measurements using whiteness-based testing described previously in this disclosure, and this comparison is performed continuously throughout the lifetime of the feature. The use of whiteness testing (as derived in the present disclosure) and continuous verification of features are important distinctions of our approach. Features that pass this statistical testing are output to estimator block 24 and image recognition block 30 for use in improving estimates of 3D motion (by blocks 24 and 30), while features that fail are dropped from the set that image processing 22 will track. If a feature is no longer being tracked due to visibility, but it recently passed the statistical testing, it is stored in memory 20 for later use.

The estimator block 24 receives input as measurements of linear acceleration from linear acceleration sensor 14, and rotational velocity from rotational velocity sensor 16, and fuses them with tracked feature coordinates from image processing block 22, that have passed the statistical testing 28 and been deemed inliers. The output 32 of this block is an estimate of 3D motion (position and orientation) along with an estimate of 3D structure (the 3D coordinates of the inlier features). This block also takes input from image recognition block 30 in the form of estimates of position derived from matching inlier features to a map stored in memory 20.

The image recognition module 30 receives currently tracked features that have been deemed inliers from statistical testing 28, and compares them to previously seen features stored in a feature map in memory 20. If matches are found, these are used to improve estimates of 3D motion by estimator 24 as additional measurements.

The memory 20 includes feature storage as a repository of previously seen features that form a map. This map can be built online through inliers found by statistical testing 28, or loaded prior to operation with external or previously built maps of the environment. These stored maps are used by image recognition block 30 to determine if any of the set of currently visible inlier features have been previously seen by the system.

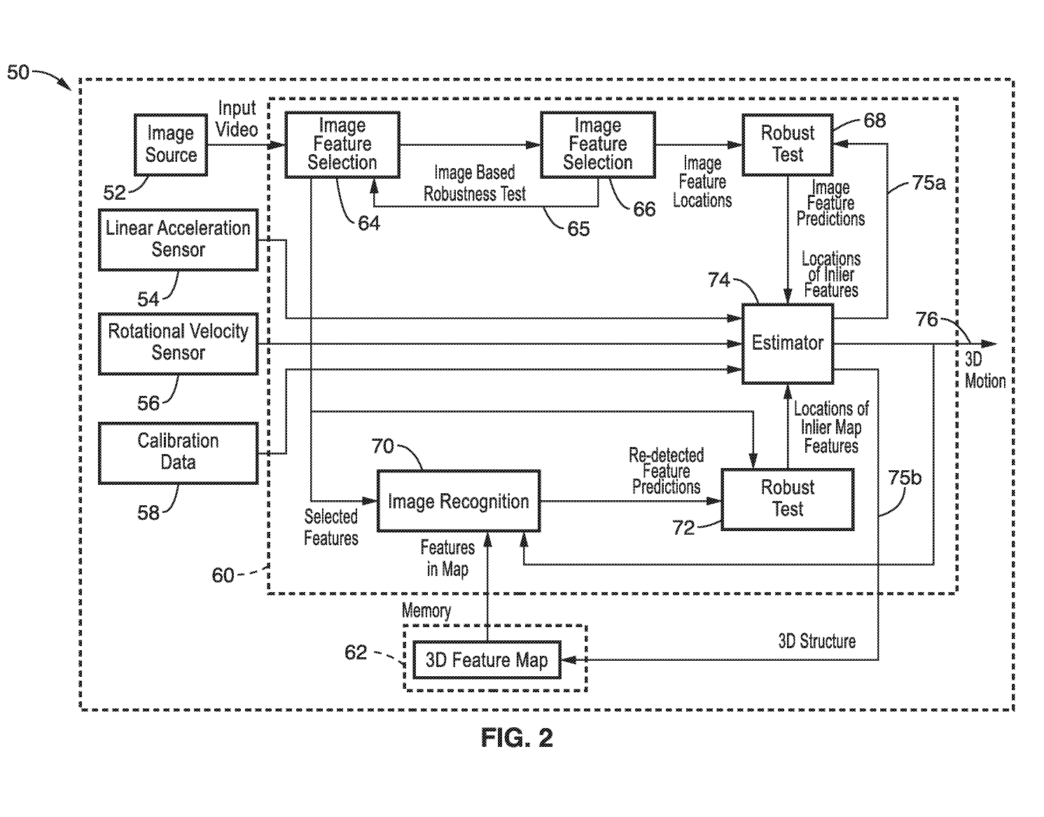

FIG. 2 illustrates a second example embodiment 50 having similar input from an image source 52, linear acceleration sensor 54, and rotational velocity sensor as was seen in FIG. 1. In addition this embodiment includes receiving a calibration data input 58, which represents the set of known (precisely or imprecisely) calibration data necessary for combining sensor information from 52, 54, and 56 into a single metric estimate of translation and orientation.

A processing block 60 is shown, which contains at least one computer processor, and at least one memory 62, that includes data space for 3D feature mapping.

In processing the inputs, the image feature selection block 64 processes images from image source 52. Features are selected on the image through a detector, which generates a set of coordinates on the image plane to an image feature tracking block 66 for image-based tracking. If the image feature tracking block 66 reports that a feature is no longer visible or has been deemed an outlier, this module will select a new feature from the current image to replace it, thus constantly providing a supply of features to track for the system to use in generating motion estimates.

The image feature tracking block 66 receives a set of detected feature coordinates from image feature selection 64, and determines their locations in subsequent image frames (from image source 52). If correspondence cannot be established (due to the feature leaving the field of view, or significant appearance differences arise), then the module will drop the feature from the tracked set and report 65 to image feature selection block 64 that a new feature detection is required.

There are two robustness test modules seen, block 68 and block 72. robust test module 68 is performed on the received image source being tracked, while robust test 72 operates on measurements derived from the stored feature map.

The robust test is another important element of the present disclosure distinguishing over previous fusion sensor systems. Input measurements of tracked feature locations are received from image feature tracking 66 along with receiving predictions of their positions provided by estimator 74, which now subsumes the functionality of block 26 from FIG. 1, for using the system's motion to estimate the 3D position of the features and generate predictions of their measurements. The robust test uses the time history of measurements and their predictions in order to continuously perform whiteness-based inlier testing while the feature is being used by estimator 74. The process of performing these tests (as previously described in this disclosure) and performing them continuously through time is a key element of the present disclosure.

The image recognition block 70 performs the same as block 30 in FIG. 1, with its input here being more explicitly shown.

The estimator 74 provides the same function as estimator 24 in FIG. 1, except for also receiving calibration data 58 and providing feature location predictions 75a based on the current motion and estimates of the 3D coordinates of features (which it generates). Estimator 74 outputs 3D motion estimates 76 and additionally outputs estimates of 3D structure 75b which are used to add to the feature map retained in memory 62.

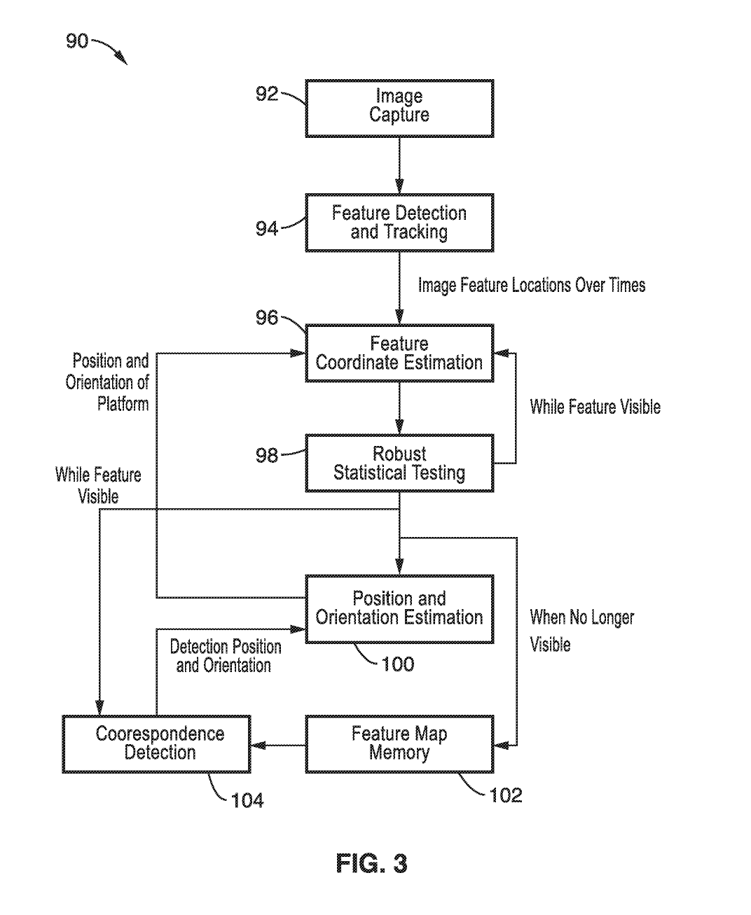

FIG. 3 illustrates an example embodiment 90 of a visual-inertial sensor fusion method. Image capturing 92 is performed to provide an image stream upon which feature detection and tracking 94 is performed. An estimation of feature coordinates 96 is performed to estimate feature locations over time. These feature estimations are then subject to robust statistical testing 98 with coordinates fed back to block 96 while features are visible. Coordinates of verified inliers are output from statistical testing step 98, to the feature memory map 102 when features are no longer visible, and to correspondence detection 104, while features are visible. Coordinates from step 98, along with position and orientation information from correspondence detection 104, are received 100 for estimating position and orientation, from which position and orientation of the platform is provided back to the coordinating estimating step 96.

The enhancements described in the presented technology can be readily implemented within various systems relying on visual-inertial sensor integration. It should also be appreciated that these visual-inertial systems are preferably implemented to include one or more computer processor devices (e.g., CPU, microprocessor, microcontroller, computer enabled ASIC, etc.) and associated memory storing instructions (e.g., RAM, DRAM, NVRAM, FLASH, computer readable media, etc.) whereby programming (instructions) stored in the memory are executed on the processor to perform the steps of the various process methods described herein. The presented technology is non-limiting with regard to memory and computer-readable media, insofar as these are non-transitory, and thus not constituting a transitory electronic signal.

### 4. Empirical Validation

To validate our analysis and investigate the design choices it suggests, we report quantitative comparison of various robust inference schemes on real data collected from a hand-held platform in artificial, natural, and outdoor environments, including aggressive maneuvers, specularities, occlusions, and independently moving objects. Since no public benchmark is available, we do not have a direct way of comparing with other VINS systems: We pick a state-of-the-art evolution of reference [17], already vetted on long driving sequences, and modify the outlier rejection mechanism as follows: (ml) Zero-point RANSAC; (m2) same with added 1-point RANSAC, (m3) m1 with added test on the history of the innovation; (m4) same with 1-point RANSAC; (m5) m3 with zero-point RANSAC and batch updates; (m6) same with 1-point RANSAC. We report end-point open-loop error, a customary performance measure, and trajectory error, measured by dynamic time-warping distance wd, relative to the lowest closed-loop drift trial.

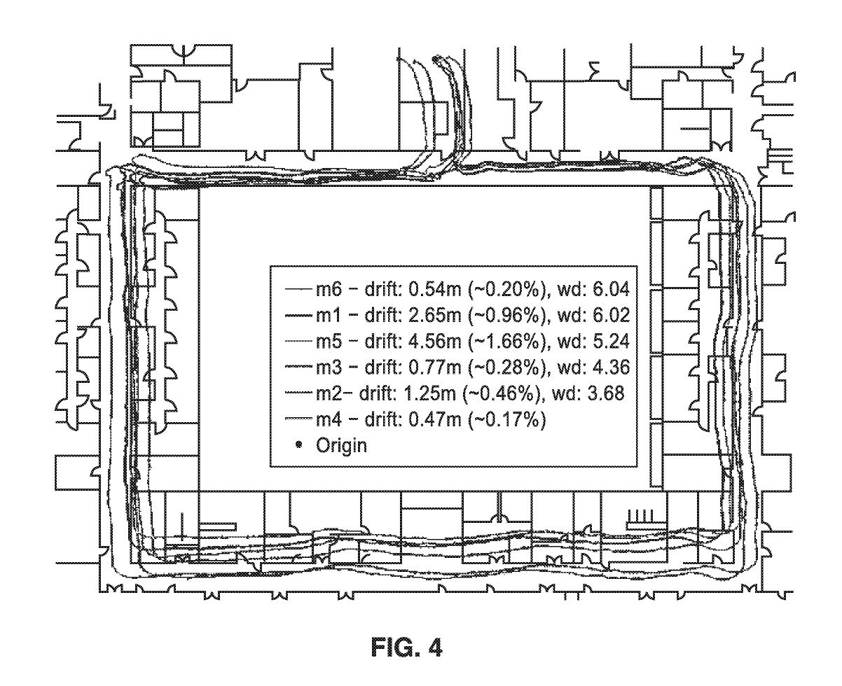

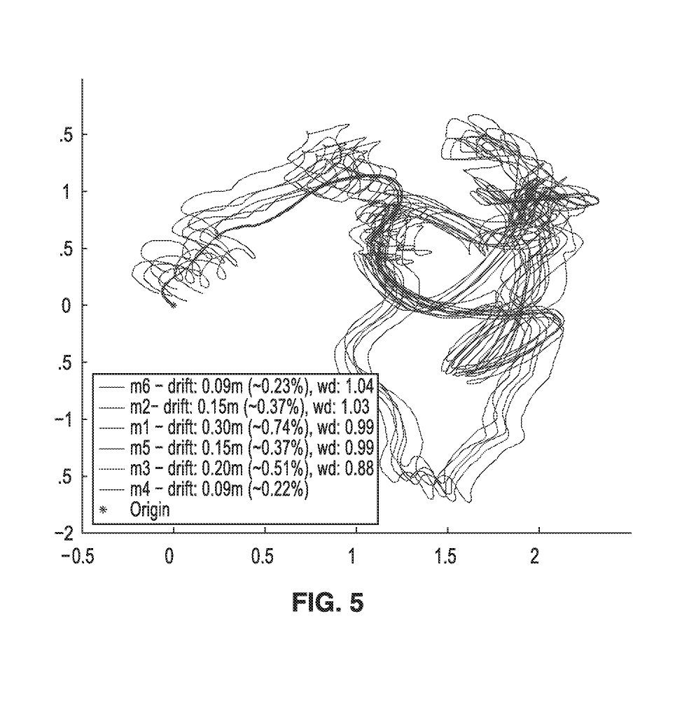

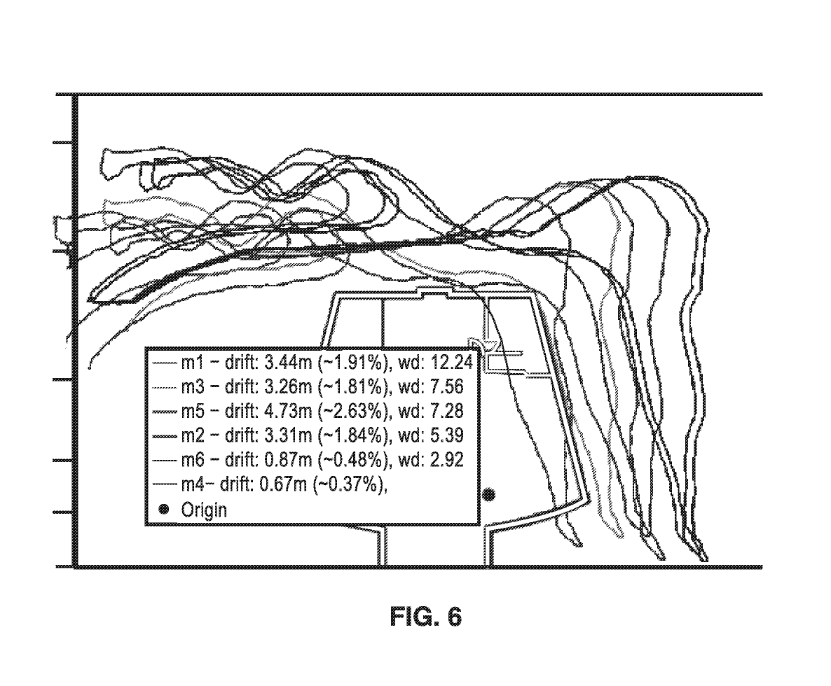

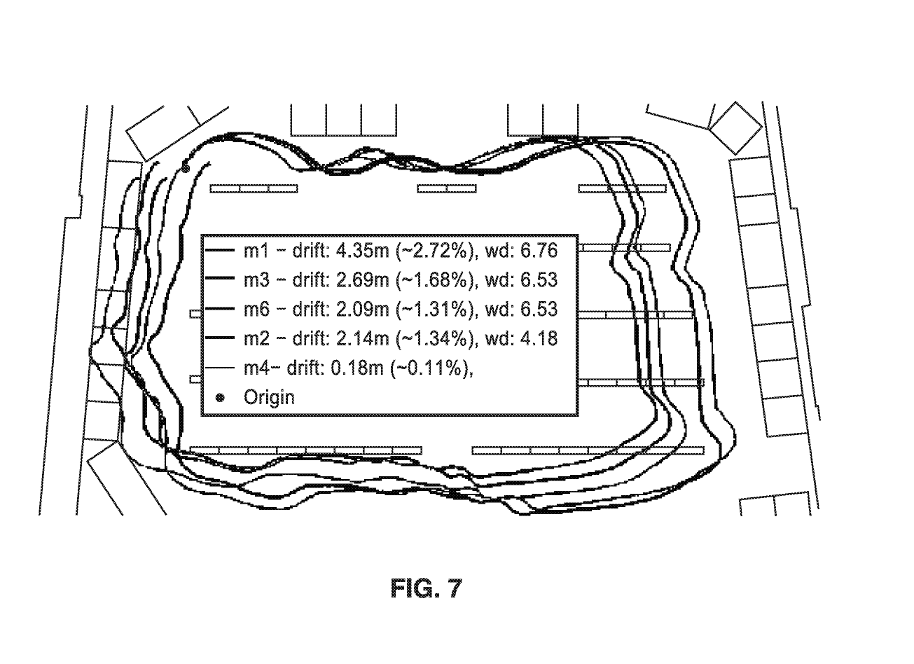

FIG. 4 through FIG. 7 show a comparison of the six schemes and their ranking according to w. All trials use the same settings and tuning, and run at frame-rate on a 2.8 Ghz Intel® Corei7™ processor, with a 30 Hz global shutter camera and an XSense MTi IMU. The upshot is that the most effective strategy is a whiteness testing on the history of the innovation in conjunction with 1-point RANSAC (m4). Based on wd, the next-best method (m2, without history of the innovation) exhibits a performance gap equal to the gap from it to the last-performing, though this is not consistent with end-point drift.

An embodiment of source code in C++ for executing method steps for the embodiment(s) described herein is set forth in Appendix A.

### 5. Discussion

We have described several approximations to a robust filter for visual-inertial sensor fusion (VINS) derived from the optimal discriminant, which is intractable. This addresses the preponderance of outlier measurements typically provided by a visual tracker, Section 2. Based on modeling considerations, we have selected several approximations, described in Section 3, and evaluated them in Section 4.

Compared to “loose integration” systems in references [27], [28], [29] where pose estimates are computed independently from each sensory modality and fused post-mortem, our approach has the advantage of remaining within a bounded set of the true state trajectory, which cannot be guaranteed by loose integration, such as in reference [14]. Also, such systems rely on vision-based inference to converge to a pose estimate, which is delicate in the absence of inertial measurements that help disambiguate local extrema and initialize pose estimates. As a result, loose integration systems typically require careful initialization with controlled motions.

Motivated by the derivation of the robustness test, whose power increases with the window of observation, we adopt a smoother, implemented as a filter on the delay-line as in reference [20], and like references [9], [30]. However, unlike the latter, we do not manipulate the measurement equation to remove or reduce the dependency of the (linearized approximation) on pose parameters. Instead, we either estimate them as part of the state if they pass the test, as in reference [15], or we infer them out-of-state using maximum likelihood, as standard in composite hypothesis testing.

We have tested different options for outlier detection, including using the history of the innovation for the robustness test while performing the measurement update at each instant, or performing both simultaneously at discrete intervals so as to avoid overlapping batches.

Our experimental evaluation has shown that in practice the scheme that best enables robust pose and structure estimation is to perform instantaneous updates using 1-point RANSAC and to continually perform inlier testing on the history of the innovation.

Embodiments of the present technology may be described with reference to flowchart illustrations of methods and systems, and/or algorithms, formulae, or other computational depictions according to embodiments of the technology, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

It will further be appreciated that “programming” as used herein refers to one or more instructions that can be executed by a processor to perform a function as described herein. The programming can be embodied in software, in firmware, or in a combination of software and firmware. The programming can be stored local to the device in non-transitory media, or can be stored remotely such as on a server, or all or a portion of the programming can be stored locally and remotely. Programming stored remotely can be downloaded (pushed) to the device by user initiation, or automatically based on one or more factors. It will further be appreciated that as used herein, that the terms processor, central processing unit (CPU), and computer are used synonymously to denote a device capable of executing the programming and communication with input/output interfaces and/or peripheral devices.

From the description herein, it will be appreciated that that the present disclosure encompasses multiple embodiments which include, but are not limited to, the following:

1. A visual-inertial sensor integration apparatus for inference of motion from a combination of inertial sensor data and visual sensor data, comprising: (a) an image sensor configured for capturing a series of images; (b) a linear acceleration sensor configured for generating measurements of linear acceleration over time; (c) a rotational velocity sensor configured for generating measurements of rotational velocity over time; (d) at least one computer processor; (e) at least one memory for storing instructions as well as data storage of feature position and orientation information; (f) said instructions when executed by the processor performing steps comprising: (f)(i) selecting image features and feature tracking performed at the pixel and/or sub-pixel level on images received from said image sensor, to output a set of coordinates on an image pixel grid; (f)(ii) estimating and outputting 3D position and orientation in response to receiving measurements of linear acceleration and rotational velocity over time, as well as receiving visible feature information from a later step (f)(iv); (f)(iii) estimating feature coordinates based on receiving said set of coordinates from step (i) and position and orientation from step (ii) to output estimated feature coordinates; (f)(iv) ongoing statistical analysis of said estimated feature coordinates from step (f)(iii) of all features currently tracked in steps (f)(i) and (f)(ii), for as long as the feature is in view, using whiteness-based testing for at least a portion of feature lifetime to distinguish inliers from outliers, with visible feature information passed to enhance estimation at step (f)(ii), and features no longer visible stored with a feature descriptor in said at least one memory; and (f)(v) performing image recognition in comparing currently tracked features to previously seen features stored in said at least one memory, and outputting information on matches to step (ii) for improving 3D motion estimates.

2. The apparatus of any preceding embodiment, wherein said whiteness-based testing determines whether residual estimates of the measurements are close to zero-mean and exhibit small temporal correlations.

3. The apparatus of any preceding embodiment, wherein said inliers are distinguished from outliers in response to determining their likelihood or posterior probability under a hypothesis that they are inliers.

4. The apparatus of any preceding embodiment, wherein said inliers are utilized in estimating 3D motion, while the outliers are not.

5. The apparatus of any preceding embodiment, wherein said ongoing statistical analysis using whiteness-based testing comprises whiteness testing in combination with a form of random-sample consensus (Ransac).

6. The apparatus of any preceding embodiment, wherein said random-sample consensus (Ransac) comprises 0-point Ransac, 1-point Ransac, or a combination of 0-point and 1-point Ransac.

7. The apparatus of any preceding embodiment, wherein steps (f)(ii) for said estimating and outputting 3D position and orientation is further configured for outputting 3D coordinates for a 3D feature map within memory.

8. The apparatus of any preceding embodiment, wherein said at least one computer processor further receives a calibration data input which represents the set of known calibration data necessary for combining data from said image sensor, said linear acceleration sensor, and said rotational velocity sensor into a single metric estimate of translation and orientation.

9. The apparatus of any preceding embodiment, wherein said apparatus is configured for use in an application selected from a group of applications consisting of navigation, localization, mapping, 3D reconstruction, augmented reality, virtual reality, robotics, autonomous vehicles, autonomous flying robots, indoor localization, and indoor localization on cellular phones.

10. A visual-inertial sensor integration apparatus for inference of motion from a combination of inertial and visual sensor data, comprising: (a) at least one computer processor; (b) at least one memory for storing instructions as well as data storage of feature position and orientation information; (c) said instructions when executed by the processor performing steps comprising: (c)(i) receiving a series of images, along with measurements of linear acceleration and rotational velocity; (c)(ii) selecting image features and feature tracking performed at the pixel and/or sub-pixel level on images received from said image sensor, to output a set of coordinates on an image pixel grid; (c)(iii) estimating 3D position and orientation to generate position and orientation information in response to receiving measurements of linear accelerations and rotational velocities over time, as well as receiving visible feature information from a later step (c)(v); (c)(iv) estimating feature coordinates based on receiving said set of coordinates from step (c)(ii) and position and orientation from step (c)(iii) to output estimated feature coordinates; (c)(v) ongoing statistical analysis of said estimated feature coordinates from step (c)(iv) of all features currently tracked in steps (c)(ii) and (c)(iii) using whiteness-based testing for at least a portion of feature lifetime to distinguish inliers from outliers, with visible feature information passed to enhance estimation at step (c)(iii), and features no longer visible stored with a feature descriptor in said at least one memory; and (c)(vi) performing image recognition in comparing currently tracked features to previously seen features stored in said at least one memory, and outputting information on matches to step (c)(iii) for improving 3D motion estimates.

11. The apparatus of any preceding embodiment, wherein said whiteness-based testing determines whether residual estimates of the measurements are close to zero-mean and exhibit small temporal correlations.

12. The apparatus of any preceding embodiment, wherein said inliers are distinguished from outliers in response to determining their likelihood or posterior probability under a hypothesis that they are inliers.

13. The apparatus of any preceding embodiment, wherein said inliers are utilized in estimating 3D motion, while the outliers are not utilized for estimating 3D motion.

14. The apparatus of any preceding embodiment, wherein said ongoing statistical analysis using whiteness-based testing comprises whiteness testing in combination with a form of random-sample consensus (Ransac).

15. The apparatus of any preceding embodiment, wherein said random-sample consensus (Ransac) comprises 0-point Ransac, 1-point Ransac, or a combination of 0-point and 1-point Ransac.

16. The apparatus of any preceding embodiment, wherein steps (iii) for said estimating and outputting 3D position and orientation is further configured for outputting 3D coordinates for a 3D feature map within memory.

17. The apparatus of any preceding embodiment, wherein said at least one computer processor further receives a calibration data input which represents the set of known calibration data necessary for combining data from said image sensor, said linear acceleration sensor, and said rotational velocity sensor into a single metric estimate of translation and orientation.

18. The apparatus of any preceding embodiment, wherein said apparatus is configured for use in an application selected from a group of applications consisting of navigation, localization, mapping, 3D reconstruction, augmented reality, virtual reality, robotics, autonomous vehicles, autonomous flying robots, indoor localization, and indoor localization on cellular phones.

19. A method of inferring motion from visual-inertial sensor integration data, comprising: (a) receiving a series of images, along with measurements of linear acceleration and rotational velocity within an electronic device configured for processing image and inertial signal inputs, and for outputting a position and orientation signal; (b) selecting image features and feature tracking performed on images received from said image sensor, to output a set of coordinates on an image pixel grid; (c) estimating 3D position and orientation to generate position and orientation information in response to receiving measurements of linear accelerations and rotational velocities over time, as well as receiving visible feature information from a later step (e); (d) estimating feature coordinates based on receiving said set of coordinates from step (b) and position and orientation from step (c) to output estimated feature coordinates as a position and orientation signal; (e) ongoing statistical analysis of said estimated feature coordinates from step (d) of all features currently tracked in steps (b) and (c) using whiteness-based testing for at least a portion of feature lifetime to distinguish inliers from outliers, with visible feature information passed to enhance estimation at step (c), and features no longer visible are stored with a feature descriptor in said at least one memory; and (f) performing image recognition in comparing currently tracked features to previously seen features stored in said at least one memory, and outputting information on matches to step (c) for improving 3D motion estimates.

20. The method of any preceding embodiment, wherein said whiteness-based testing determines whether residual estimate of the measurements, which are themselves a random variance, are close to zero-mean and exhibit small temporal correlations.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

1. A visual-inertial sensor integration apparatus for inference of motion from a combination of inertial sensor data and visual sensor data, comprising:
(a) an image sensor configured for capturing a series of images;
(b) a linear acceleration sensor configured for generating measurements of linear acceleration over time;
(c) a rotational velocity sensor configured for generating measurements of rotational velocity over time;
(d) at least one computer processor;
(e) at least one memory for storing instructions as well as data storage of feature position and orientation information;
(f) said instructions when executed by the processor performing steps comprising:
(i) selecting image features and feature tracking performed at the pixel and/or sub-pixel level on images received from said image sensor, to output a set of coordinates on an image pixel grid;
(ii) estimating and outputting 3D position and orientation in response to receiving measurements of linear acceleration and rotational velocity over time, as well as receiving visible feature information from a later step (iv);
(iii) estimating feature coordinates based on receiving said set of coordinates from step (i) and position and orientation from step (ii) to output estimated feature coordinates;
(iv) ongoing statistical analysis of said estimated feature coordinates from step (iii) of all features currently tracked in steps (i) and (ii), for as long as the feature is in view, using whiteness-based testing for at least a portion of feature lifetime to distinguish inliers from outliers, with visible feature information passed to enhance estimation at step (ii), and features no longer visible stored with a feature descriptor in said at least one memory;
(v) wherein said whiteness-based testing comprises testing assumptions about inliers based on conditional independence of said inliers given said estimated 3D position, orientation, and feature coordinates, implying a prediction residual history, under the posterior probability of said residuals as predicted using linear acceleration and rotational velocity measurements, which is temporally uncorrelated and/or statistically white; and
(vi) performing image recognition in comparing currently tracked features to previously seen features stored in said at least one memory, and outputting information on matches to step (ii) for improving 3D motion estimates.

2. The apparatus of claim 1, wherein said whiteness-based testing determines whether residual estimates of the measurements are close to zero-mean and exhibit no temporal correlations.

3. (canceled)

4. The apparatus of claim 1, wherein said inliers are utilized in estimating 3D motion, while the outliers are not.

5. The apparatus of claim 1, wherein said ongoing statistical analysis using whiteness-based testing comprises whiteness testing in combination with a form of random-sample consensus (RANSAC).

6. The apparatus of claim 5, wherein said random-sample consensus (RANSAC) comprises 0-point RANSAC, 1-point RANSAC, or a combination of 0-point and 1-point RANSAC.

7. The apparatus of claim 1, wherein steps (f)(ii) for said estimating and outputting 3D position and orientation is further configured for outputting 3D coordinates for a 3D feature map within memory.

8. The apparatus of claim 1, wherein said at least one computer processor further receives a calibration data input which represents the set of known calibration data necessary for combining data from said image sensor, said linear acceleration sensor, and said rotational velocity sensor into a single metric estimate of translation and orientation.

9. The apparatus of claim 1, wherein said apparatus is configured for use in an application selected from a group of applications consisting of navigation, localization, mapping, 3D reconstruction, augmented reality, virtual reality, robotics, autonomous vehicles, autonomous flying robots, indoor localization, and indoor localization on cellular phones.

10. A visual-inertial sensor integration apparatus for inference of motion from a combination of inertial and visual sensor data, comprising:
(a) at least one computer processor;
(b) at least one memory for storing instructions as well as data storage of feature position and orientation information;
(c) said instructions when executed by the processor performing steps comprising:
(i) receiving a series of images, along with measurements of linear acceleration and rotational velocity;
(ii) selecting image features and feature tracking performed at the pixel and/or sub-pixel level on images received from said image sensor, to output a set of coordinates on an image pixel grid;
(iii) estimating 3D position and orientation to generate position and orientation information in response to receiving measurements of linear accelerations and rotational velocities over time, as well as receiving visible feature information from a later step (v);
(iv) estimating feature coordinates based on receiving said set of coordinates from step (ii) and position and orientation from step (iii) to output estimated feature coordinates;
(v) ongoing statistical analysis of said estimated feature coordinates from step (iv) of all features currently tracked in steps (ii) and (iii) using whiteness-based testing for at least a portion of feature lifetime to distinguish inliers from outliers, with visible feature information passed to enhance estimation at step (iii), and features no longer visible stored with a feature descriptor in said at least one memory;
(vi) wherein said whiteness-based testing comprises testing assumptions about inliers based on conditional independence of said inliers given said estimated 3D position, orientation, and feature coordinates implying a prediction residual history, under the posterior probability of said residuals as predicted using linear acceleration and rotational velocity measurements, which is temporally uncorrelated and/or statistically white; and
(vii) performing image recognition in comparing currently tracked features to previously seen features stored in said at least one memory, and outputting information on matches to step (iii) for improving 3D motion estimates.

11. The apparatus of claim 10, wherein said whiteness-based testing determines whether residual estimates of the measurements are close to zero-mean and exhibit small temporal correlations.

12. (canceled)

13. The apparatus of claim 10, wherein said inliers are utilized in estimating 3D motion, while the outliers are not utilized for estimating 3D motion.

14. The apparatus of claim 10, wherein said ongoing statistical analysis using whiteness-based testing comprises whiteness testing in combination with a form of random-sample consensus (RANSAC).

15. The apparatus of claim 14, wherein said random-sample consensus (RANSAC) comprises 0-point RANSAC, 1-point RANSAC, or a combination of 0-point and 1-point RANSAC.

16. The apparatus of claim 10, wherein steps (c)(iii) for said estimating and outputting 3D position and orientation is further configured for outputting 3D coordinates for a 3D feature map within memory.

17. The apparatus of claim 10, wherein said at least one computer processor further receives a calibration data input which represents the set of known calibration data necessary for combining data from said image sensor, said linear acceleration sensor, and said rotational velocity sensor into a single metric estimate of translation and orientation.

18. The apparatus of claim 10, wherein said apparatus is configured for use in an application selected from a group of applications consisting of navigation, localization, mapping, 3D reconstruction, augmented reality, virtual reality, robotics, autonomous vehicles, autonomous flying robots, indoor localization, and indoor localization on cellular phones.

19. A method of inferring motion from visual-inertial sensor integration data, comprising:
(a) receiving a series of images, along with measurements of linear acceleration and rotational velocity within an electronic device configured for processing image and inertial signal inputs;
(b) selecting image features and feature tracking performed at the pixel and/or sub-pixel level on images received from said image sensor, to output a set of coordinates on an image pixel grid;
(c) estimating 3D position and orientation to generate position and orientation information in response to receiving measurements of linear accelerations and rotational velocities over time, as well as receiving visible feature information from a later step (e);
(d) estimating feature coordinates based on receiving said set of coordinates from step (b) and position and orientation from step (c) to output estimated feature coordinates as a position and orientation signal;
(e) ongoing statistical analysis of said estimated feature coordinates from step (d) of all features currently tracked in steps (b) and (c) using whiteness-based testing for at least a portion of feature lifetime to distinguish inliers from outliers, with visible feature information passed to enhance estimation at step (c), and features no longer visible stored with a feature descriptor in said at least one memory;
(f) wherein said whiteness-based testing comprises testing assumptions about inliers based on conditional independence of said inliers given said estimated 3D position, orientation, and feature coordinates, implying a prediction residual history, under the posterior probability of said residuals as predicted using linear acceleration and rotational velocity measurements, which is temporally uncorrelated and/or statistically white; and
(g) performing image recognition in comparing currently tracked features to previously seen features stored in said at least one memory, and outputting information on matches to step (c) for improving 3D motion estimates.

20. The method of claim 19, wherein said whiteness-based testing determines whether residual estimates of the measurements are close to zero-mean and exhibit small temporal correlations.
